(19) United States
(12) Patent Application Publication
(10) Pub. No.: US 2013/0229341 A1
(43) Pub. Date: Sep. 5, 2013

(54) HANDWRITING INPUT DEVICE AND COMPUTER-READABLE MEDIUM

(71) Applicant: CASIO COMPUTER CO., LTD., Tokyo (JP)

(72) Inventor: Takaaki YUI, Tokyo (JP)

(73) Assignee: CASIO COMPUTER CO., LTD., Tokyo (JP)

(21) Appl. No.: 13/783,002

(22) Filed: Mar. 1, 2013

(30) Foreign Application Priority Data
Mar. 2, 2012 (JP) 2012-047062

(51) Int. Cl. G06F 3/01

(52) U.S. Cl. CPC G06F 3/01
USPC 345/156

(57) ABSTRACT

A position detecting unit is configured to detect an access position and a contact position of an operation tool. A guide figure display unit is configured to, when an access position of the operation tool is detected by the position detecting unit, display a guide figure for handwriting input on the display unit based on the detected access position. A handwriting position display unit is configured to, when a contact position of the operation tool is detected by the position detecting unit in a state where the guide figure is displayed by the guide figure display unit, display a locus of the detected contact position on the display unit.

### CROSS-REFERENCE TO RELATED APPLICATIONS

This application is based upon and claims the benefit of priority from prior Japanese Patent Application No. 2012-047062, filed Mar. 2, 2012, the entire contents of which are incorporated herein by reference.

### BACKGROUND OF THE INVENTION

1. Field of the Invention

The present invention relates to a handwriting input device configured to input a handwritten character or figure, and a computer-readable medium having a program stored thereon.

2. Description of the Related Art

In recent years, information terminals such as a personal digital assistant (PDA), personal computer (PC), cellular phone, electronic dictionary, portable game device, and the like, provided with a tablet or a touch-screen display and capable of inputting a character or a figure by handwriting, are widely in practical use.

On a display unit of such an information terminal, display corresponding to various functions is carried out naturally, and hence it is not possible to fixedly display, for example, a mark for inputting a character by handwriting. Accordingly, there is a problem that rows of character strings input by handwriting, and the size of the characters are likely to be disordered, and the character strings cannot be written well.

Thus, a handwritten character input device provided with a function of neatly arranging handwritten characters and facilitating input of the handwritten characters by detecting, at the time of input of characters by handwriting, a first touching position on a tablet or a touchpanel, and using a position apart from the first touching position by a predetermined distance in a predetermined direction as an origin to thereby define a virtual frame for input of characters, and guide input of characters, is contrived (for example, Jpn. Pat. Appln. KOKAI Publication No. 09-091377).

In a conventional handwritten character input device, although it is possible to detect a first touching position on a tablet or a touchpanel, and define a virtual frame for carrying out handwriting using the touching position as a writing position of the first character, guiding of input of characters is not carried out before the tablet or the touchpanel is actually touched. Accordingly, it is not possible to confirm a position at which handwriting is to be started before the tablet or the touchpanel is actually touched, thereby causing a problem that the device lacks operability for neatly inputting handwritten characters.

### BRIEF SUMMARY OF THE INVENTION

Accordingly, it is an object of the present invention to provide a handwriting input device and computer-readable medium having a program stored thereon, each of which makes it possible to appropriately guide a user to a write position from the time at which input of handwritten characters is actually started.

According to one aspect of the present invention, there is provided a handwriting input device comprising: a display unit; a position detecting unit provided integral with the display unit and configured to detect an access position and a contact position of an operation tool; a guide figure display unit configured to, when an access position of the operation tool is detected by the position detecting unit, display a guide figure for handwriting input on the display unit based on the detected access position; and a handwriting position display unit configured to, when a contact position of the operation tool is detected by the position detecting unit in a state where the guide figure is displayed by the guide figure display unit, display a locus of the detected contact position on the display unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing the external configuration of a tablet information terminal device 10 according to an embodiment of a handwriting input device of the present invention;

FIG. 2 is a block diagram showing the configuration of an electronic circuit of the information terminal device 10;

FIG. 3 is a view showing the contents of a guide figure database 22d to be stored in a storage device 22 of the information terminal device 10;

FIG. 4 is a view showing a display operation concomitant with guide display processing according to a first embodiment carried out in accordance with a handwriting input operation of the information terminal device 10;

FIG. 5 is a flowchart showing the guide display processing according to the first embodiment carried out in accordance with the handwriting input operation of the information terminal device 10;

FIG. 6 is a flowchart showing guide display processing according to a second embodiment carried out in accordance with the handwriting input operation of the information terminal device 10;

FIGS. 7A, 7B, 7C, 7D and 7E show views each showing a display operation concomitant with the guide display processing according to the second embodiment carried out in accordance with the handwriting input operation of the information terminal device 10;

FIGS. 8A, 8B and 8C show views each showing a display operation concomitant with guide display processing according to a third embodiment carried out in accordance with the handwriting input operation of the information terminal device 10; and

FIGS. 9A, 9B, 9C, 9D, 9E and 9F show views each showing a display operation concomitant with guide display processing according to a fourth embodiment carried out in accordance with the handwriting input operation of the information terminal device 10.

### DETAILED DESCRIPTION OF THE INVENTION

Hereinafter, embodiments of the present invention will be described by using the drawings.

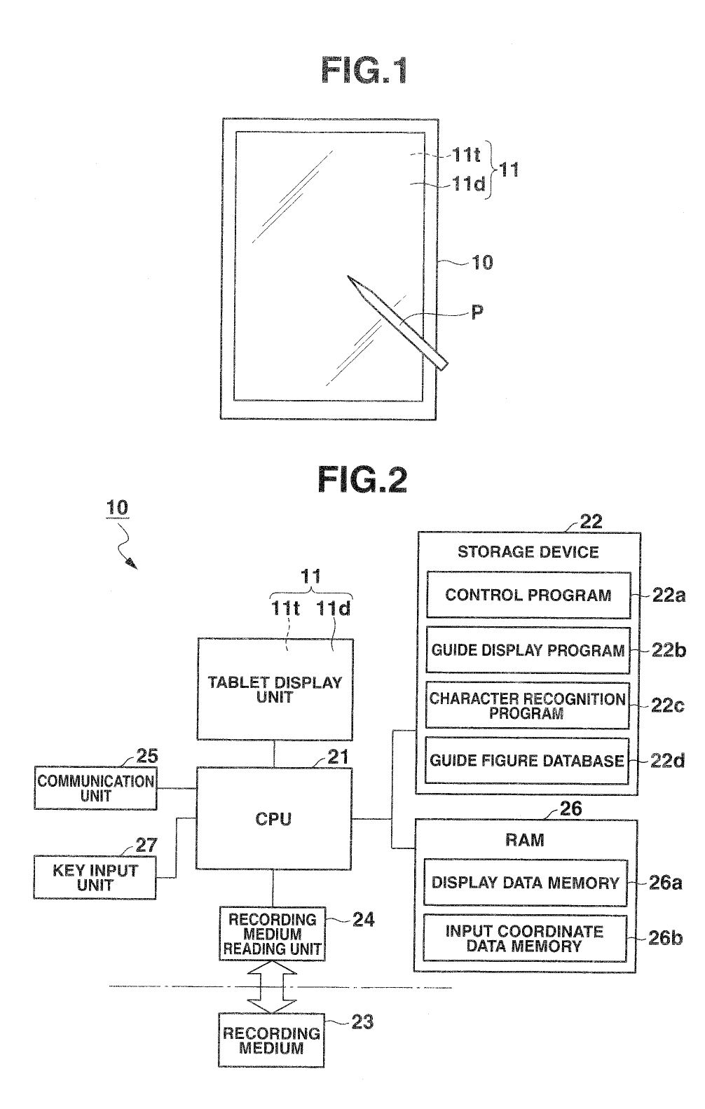

FIG. 1 is a front view showing the external configuration of a tablet information terminal device according to an embodiment of a handwriting input device of the present invention.

This information terminal device 10 (which may be referred to as a handwriting input device) is provided with, for example, a 12-inch tablet display unit 11. This tablet display unit 11 is constituted by overlaying a dot-matrix color liquid crystal display screen lid and a tablet 11t with each other. As this tablet 11t, for example, an electromagnetic induction tablet is used. Both an access position and contact position of a stylus P (which may be referred to as an operation tool) incorporating therein an induction coil at a distal end thereof on the display screen of the tablet 11t are detected as coordinates of the display screen (which may be referred to as a position detecting unit).

This information terminal device 10 operates in accordance with touch operations for various data items displayed on the tablet display unit 11 except for an operation of a power key switch for turning-on/off the power. Further, the information terminal device 10 also has a function of recognizing and inputting a handwritten character or figure (which may be referred to as a handwriting position display unit).

FIG. 2 is a block diagram showing the configuration of an electronic circuit of the information terminal device 10.

A CPU 21 which is a computer is provided in the electronic circuit of the information terminal device 10. The CPU 21 controls an operation of each unit of the circuit in accordance with a terminal control program stored in advance in a storage device 22, or a terminal control program read from an external recording medium 23 such as a memory card or the like into the storage device 22 through a recording medium reading unit 24, or a terminal control program read from a Web server on a communication network into the storage device 22 through a communication unit 25 by using the storage device 22 and a RAM 26 as a work memory.

As the terminal control program stored in the storage device 22, a control program 22a including a communication control program for communicating with an electronic device provided with a communication function, such as an external PC, Web server, and the like through the communication unit 25, and various application programs for carrying out text processing, table processing, image/sound reproduction processing, mail processing, operation processing, and the like, guide display program 22b for guiding to a write position of handwriting input when the handwritten information is input to the tablet display unit 11, and character recognition program 22c for recognizing various characters and figures input by handwriting are stored.

Further, in the storage device 22, a guide figure database 22d to be used concomitantly with execution of the guide display program 22b is stored.

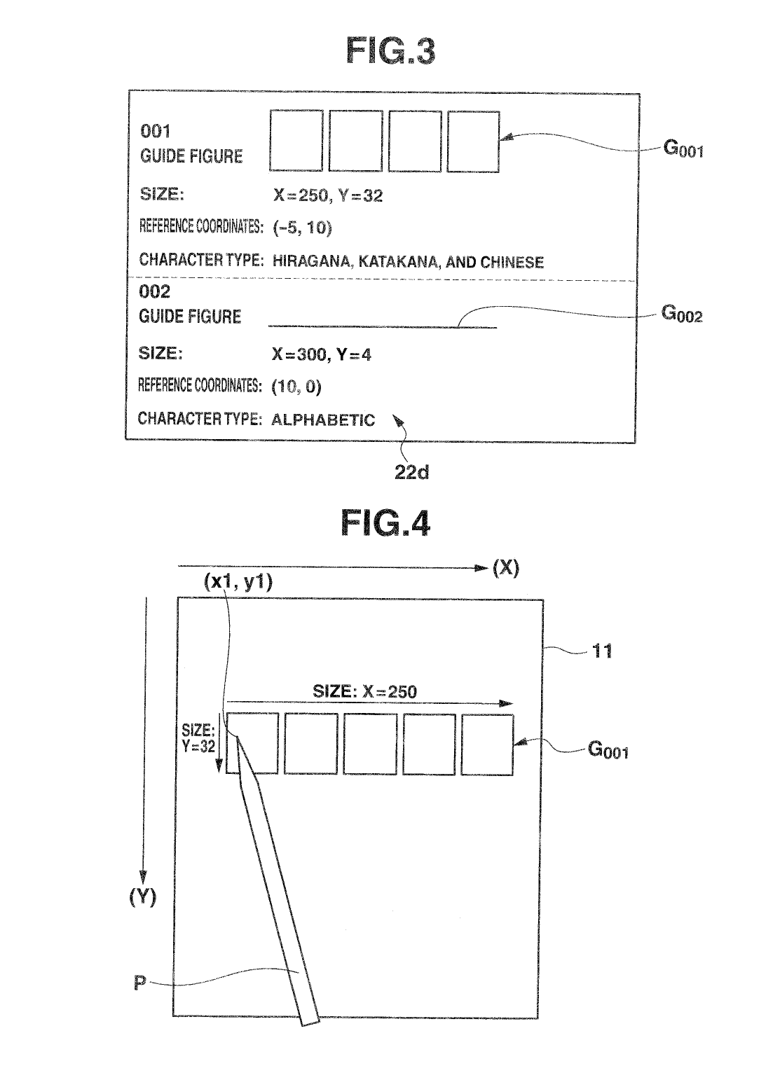

FIG. 3 is a view showing the contents of the guide figure database 22d to be stored in the storage device 22 of the information terminal device 10.

In this guide figure database 22d, guide figure data for guiding to a write position of handwriting input to the tablet display unit 11 is stored. More specifically, various guide figures G001 (squares for a hiragana character, katakana character, and Chinese character), G002 (underline for alphabetic characters), . . . corresponding to types of input characters or figures are stored together with their sizes [X=◯◯◯, Y=ΔΔΔ], reference coordinates (X, Y), and corresponding character types.

Here, the size [X=◯◯◯, Y=ΔΔΔ] of a guide figure Gn indicates a coordinate range required for development in the display screen area, and the reference coordinates (X, Y) indicate the optimum write starting position set in advance by using the coordinates of an upper-left position of the range (size) of the corresponding guide figure as an origin.

In the aforementioned RAM 26, a display data memory 26a, input coordinate data memory 26b, and the like are secured as a storage area for various operations.

The display data memory 26a includes a storage area of color bitmap data corresponding to the display screen area of the tablet display unit 11, and display screen data created in accordance with a program being executed is stored in the memory 26a.

Coordinates of an access position and contact position of the stylus P detected by the tablet 11t of the display unit 11 concomitantly with the handwriting input to the tablet display unit 11 carried out by the user are stored in the input coordinate data memory 26b.

As described above, the storage device 22, recording medium reading unit 24, communication unit 25, RAM 26, key input unit 27, tablet display unit 11 are connected to the CPU 21, thereby constituting the device 10.

Further, the information terminal device 10 has a function of displaying (which may be referred to as a guide figure display unit) a guide figure Gn when the stylus P is made to approach the tablet display unit 11 at the time of handwriting input corresponding to a user operation on the tablet display unit 11 such that the reference coordinates (X, Y) of the guide figure Gn stored in the guide figure database 22d coincide with coordinates (x1, y1) of the access position of the stylus P detected by the tablet 11t, and guiding the user to an input position of the handwriting carried out by the user.

In the information terminal device 10 configured as described above, the CPU 21 controls an operation of each unit of the circuit in accordance with commands described in the terminal control programs 22a, 22b, and 22c, and software and hardware operate in cooperation with each other, whereby the guide display function concomitant with the handwriting input processing to be described in the following operation description is realized.

Next, an operation of the information terminal device 10 provided with the handwriting input function configured as described above will be described below.

### First Embodiment

FIG. 4 is a view showing a display operation concomitant with guide display processing according to a first embodiment carried out in accordance with a handwriting input operation of the information terminal device 10.

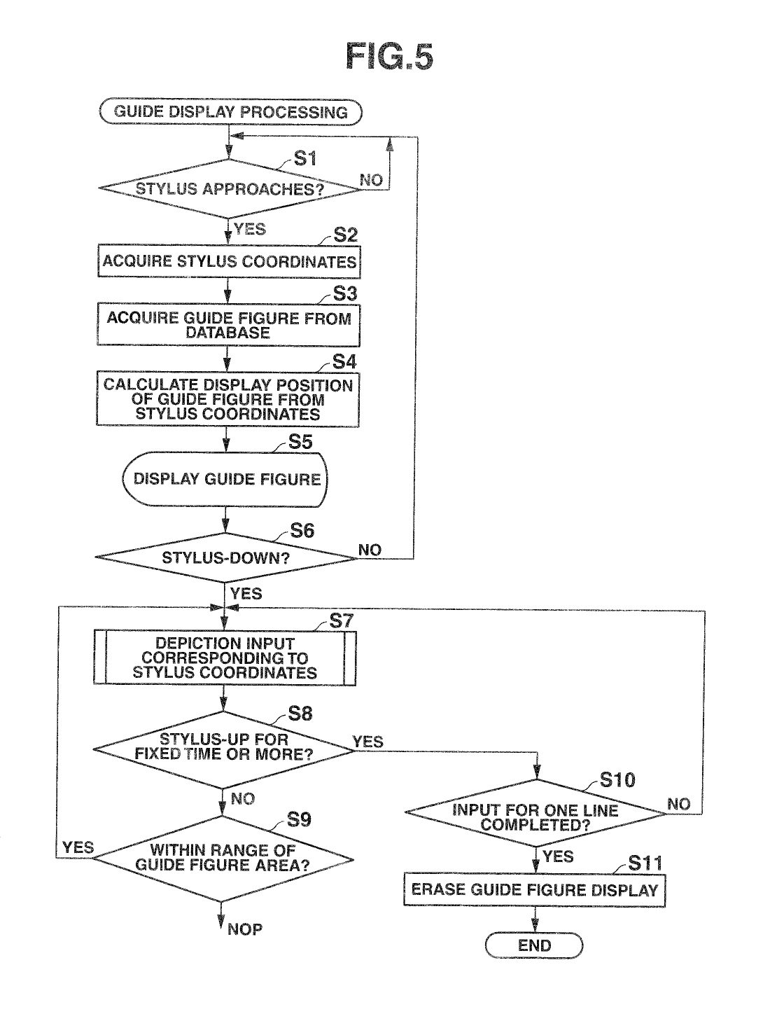

FIG. 5 is a flowchart showing the guide display processing according to the first embodiment carried out in accordance with the handwriting input operation of the information terminal device 10.

When the user makes the stylus P approach the display screen of the tablet display 11 in a state where the information terminal device 10 is placed in the handwriting input mode, it is detected by the tablet 11t that the stylus P has approached the display screen (step S1: YES). Coordinates (x1, y1) of the access position are acquired from the tablet 11t and stored in the input coordinate data memory 26b (step S2).

Then, a guide figure (the guide figure G001 [for hiragana, katakana, and Chinese characters] in this embodiment) is read from the guide figure database 22d (shown in FIG. 3) (step S3). A display position (for example, coordinates indicating the origin of the guide figure) of the guide figure G001 of the case where the reference coordinates (−5, −10) of the guide figure G001 coincide with the coordinates (x1, y1) of the access position of the stylus P on the display screen is calculated (step S4).

Further, the read guide figure G001 is displayed on the tablet display unit 11 in accordance with the calculated display position (step S5).

That is, when the stylus P approaches the tablet display unit 11, and the access position thereof is detected by the tablet 11t, the guide figure G001 which makes the coordinates (x1, y1) of the detected access position correspond to the optimum write starting position is displayed. Further, in a state where the stylus-down (contact position) of the stylus P on the display screen is not detected (step S6: NO), the guide figure G001 is moved in accordance with the movement of the coordinates (x1, y1) of the access position of the stylus P, and is displayed on the display screen (steps S1 to S5), and hence it is possible to confirm the optimum write starting position before the characters are actually written.

After this, when write of characters is started by using the stylus P while the guide figure G001 displayed on the display screen is referred to, coordinates of the contact position of the stylus P on the tablet display unit 11 are detected simultaneously with the start of write (step S6: YES).

Then, the display position of the guide figure G001 on the tablet display unit 11 is fixed thereto, and a locus of the movement of the detected contact position of the stylus P is depicted and displayed (step S7). It should be noted that when the coordinates of the position at which the stylus P is brought into contact with the display unit 11 are detected in step S6, the display position of the guide figure G001 on the tablet display unit 11 is fixed thereto, and a locus of the movement of the detected contact position of the stylus P may be depicted and displayed after the stylus-up is once carried out.

Further, even when the contact position of the stylus P temporarily becomes undetected because of, for example, a break concomitant with the handwriting within one character or a break between characters, if the duration of the state is shorter than a fixed time (step S8: NO), and the access position or the contact position of the stylus P detected again is within the area of the displayed guide figure G001 (step S9: YES), a locus of the movement of the contact position of the stylus P detected again is depicted and displayed (step S7).

Further, even when it is determined that a fixed time or more has elapsed from the time at which the contact position of the stylus becomes undetected (step S8: YES), a locus of the movement of the contact position of the stylus P detected again is depicted and displayed in the area of the guide figure G001 (steps S7 to S9).

It should be noted that the squares for a hiragana character, katakana character, and Chinese character (shown in FIG. 3) constituting the guide figure G001 of the first embodiment are constituted of a combination of those of a preset number (for example, four). When the contact position of the stylus P is detected in the area of the last (fourth) square of the guide figure G001 concomitantly with the input of handwritten characters corresponding to the guide figure G001, a new guide figure G001 of the same set is displayed to be continued from the right end (tail end) of the currently displayed guide figure G001 on the basis of the size [X=◯◯◯, Y=ΔΔΔ] of the new guide figure G001, and this procedure is repeated until the newly displayed guide figure reaches a position a predetermined distance short of the right end of the display screen having a width corresponding to one line of writing.

After this, when it is determined that a fixed time or more has elapsed from the time at which the contact position of the stylus becomes undetected (step S8: YES), if it is determined that handwriting input for one line corresponding to the guide figure G001 has been completed (step S10: YES), the guide figures G001 displayed so far on the corresponding one line are erased (step S11). It should be noted that when a time longer than the fixed time used in step S8 is set, and the stylus-up is kept for a time longer than the set time, the guide figures G001 may be erased while determining that the handwriting input has been completed (which may be referred to as a guide figure erasing unit).

Therefore, according to the guide display processing of the first embodiment of the information terminal device 10 provided with the handwriting input function and configured as described previously, it is possible for the user to sequentially write and depict characters by handwriting from the beginning of the write of the characters at appropriate positions on the basis of the guide figure G001 to be displayed on the display screen from the time immediately before the handwriting input to the tablet display unit 11 is started by using the stylus P, and it is further possible to greatly improve the operability for nearly inputting handwritten characters.

### Second Embodiment

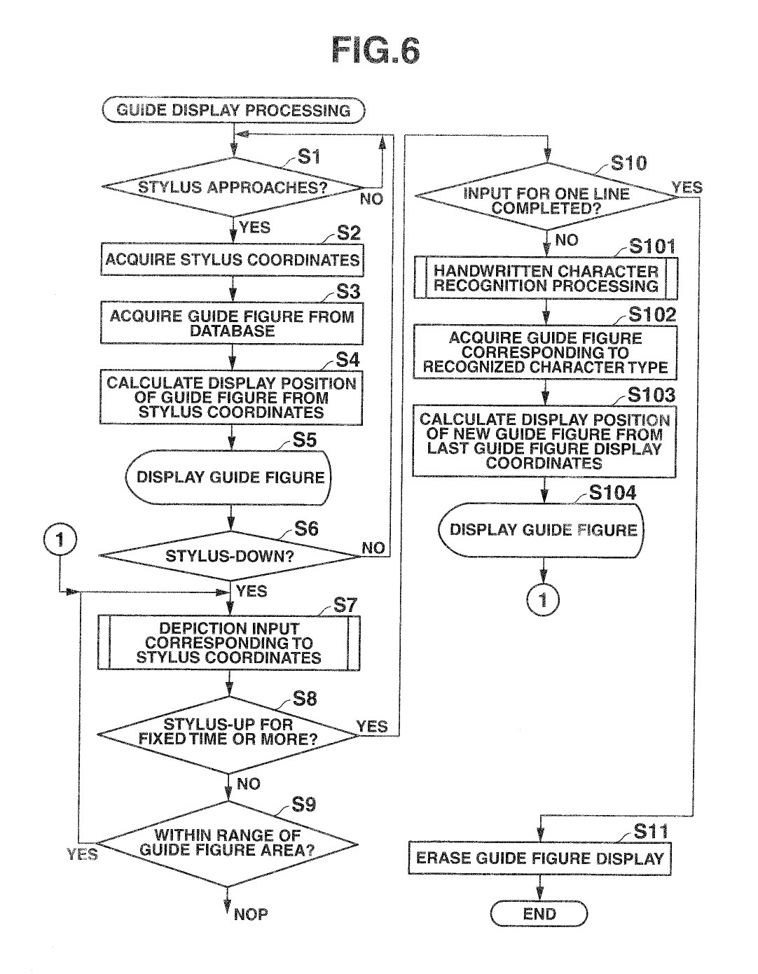

FIG. 6 is a flowchart showing guide display processing according to a second embodiment carried out in accordance with a handwriting input operation of the information terminal device 10.

In the flowchart showing the guide processing of the second embodiment in FIG. 6, processing steps identical to the flowchart of the first embodiment in FIG. 5 are denoted by step reference symbols identical to those in FIG. 5, and a description of them is omitted.

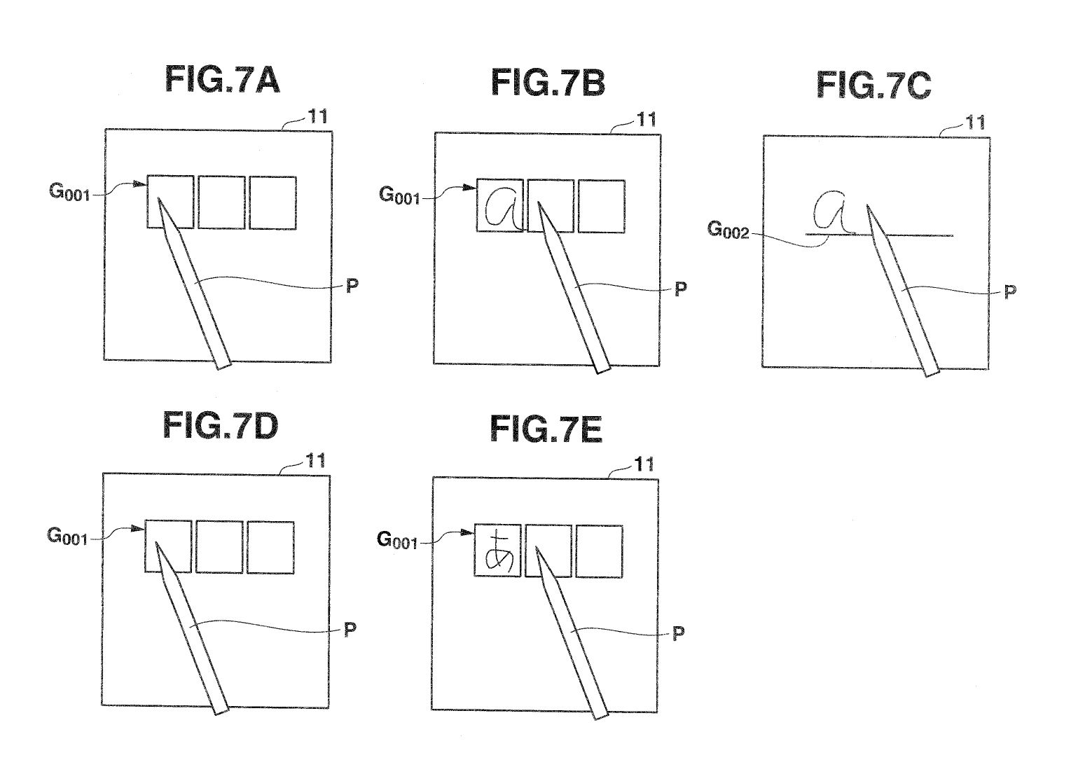

FIGS. 7A, 7B, 7C, 7D and 7E show views each showing a display operation concomitant with the guide display processing according to the second embodiment carried out in accordance with the handwriting input operation of the information terminal device 10.

In the guide display processing according to the second embodiment, a character type of a character input by handwriting is recognized in addition to the guide display processing (steps S1 to S11) of the first embodiment and, when the character type of the already displayed guide figure G001 is different from the recognized character type, processing (steps S101 to S104) of switching display to a new guide figure G002 for the recognized character type, and displaying the new guide figure G002 is added.

It should be noted that in the second embodiment, in the guide figure Gn to be read first from the guide figure database 22d and displayed by detection of the coordinates (x1, y1) of the access position of the stylus P, guide figure G001 for hiragana, katakana, and Chinese characters is set to a default.

That is, as shown in FIG. 7A, when the stylus P approaches the display screen of the tablet display unit 11, and the coordinates (x1, y1) of the access position thereof are detected, a guide figure G001 for the default-set character types (hiragana, katakana, and Chinese) is read from the guide figure database 22d on the basis of the coordinates (x1, y1) of the access position, and is displayed (steps S1 to S5).

Further, as shown in, for example, FIG. 7B, when a handwritten character “a” of the alphabet is input and depicted in accordance with the first square of guide figure G001 (steps S6 to S9), it is determined concomitantly with an operation of moving the stylus P to the next square that the coordinates of the contact position of the stylus P are not detected for a fixed time or more (step S8: YES) and, furthermore it is determined that handwriting input for one line corresponding to guide figure G001 has not been completed yet (step S10: NO), the depicted handwritten character “a” is character-recognized (step S101) (which may be referred to as a character recognition unit).

Then, guide figure G002 for the alphabetic character stored in the guide figure database 22d is read from the database 22d in accordance with the character type [alphabetic] of the character-recognized handwritten character (step S102) (which may be referred to as a figure switch/display unit).

Further, a display position of guide figure G002 for the alphabetic character newly read from the guide figure database 22d is calculated on the basis of the display position of the currently displayed guide figure G001 displayed in the guide display processing (steps S4 and S5) of the last time (step S103). As shown in FIG. 7C, the new guide figure G002 is displayed in place of the current guide figure G001 (step S104).

Thereby, handwritten characters of the alphabetic character to be input by handwriting by referring to the newly displayed guide figure G002 for the alphabetic character are sequentially depicted and displayed in the area of guide figure G002 subsequent to the alphabetic character “a” input and depicted by handwriting (steps S7 to S9).

After this, when it is determined that a fixed time or more has elapsed from the time at which the contact position of the stylus becomes undetected (step S8: YES), if it is determined that handwriting input for one line corresponding to guide figure G002 has been completed (step S10: YES), the corresponding guide figure G002 for the one line is erased (step S11).

It should be noted that according to the guide display processing of the second embodiment shown in FIG. 6, when the character type [hiragana] of the handwritten character “ [symbol] ” input by handwriting in accordance with the currently displayed guide figure G001 for hiragana, katakana, and Chinese characters corresponds to the character type of guide figure G001 as shown in, for example, FIGS. 7D and 7E, the same guide figure G001 is repetitively overwritten and displayed. However, in such a case, the configuration in which the processing of switching the guide figure to the new guide figure Gn of steps S102 to S104 is omitted may be employed.

Therefore, according to the guide display processing of the second embodiment of the information terminal device 10 provided with the handwriting input function and configured as described previously, it is possible for the user to sequentially write and depict characters by handwriting from the beginning of the write of the characters at appropriate positions on the basis of guide figure G001 to be displayed on the display screen from the time immediately before the handwriting input to the tablet display unit 11 is started by using the stylus P. Further, it is possible to display an appropriate guide figure G002 at all times in accordance with the character type of the character actually input by handwriting. Furthermore, it is possible to greatly improve the operability for neatly inputting handwritten characters in various character types.

### Third Embodiment

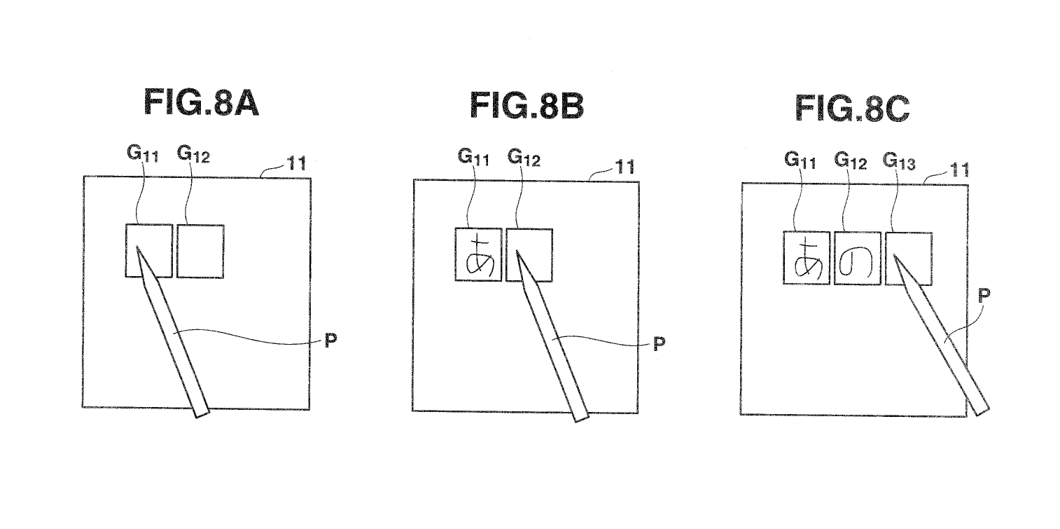

FIGS. 8A, 8B and 8C show views each showing a display operation concomitant with guide display processing according to a third embodiment carried out in accordance with a handwriting input operation of the information terminal device 10.

In the guide display processing according to the third embodiment, the configuration is employed in which the guide figure Gn to be stored in the guide figure database 22d is constituted of, for example, guide figures G11 and G12 for two characters and, each time one handwritten character is input and recognized on a one-by-one basis in accordance with guide figures G11 and G12, succeeding guide figures G13, . . . are additionally displayed in sequence subsequent to the currently displayed guide figures G11 and G12 (which may be referred to as a guide figure addition/display unit).

According to the above, it is possible for the user to clearly recognize guide figures Gn . . . to be extensionally displayed subsequent to the input position of the handwritten characters while further inputting handwritten characters, and it is possible to impart a more effective guiding function to the information terminal device 10.

### Fourth Embodiment

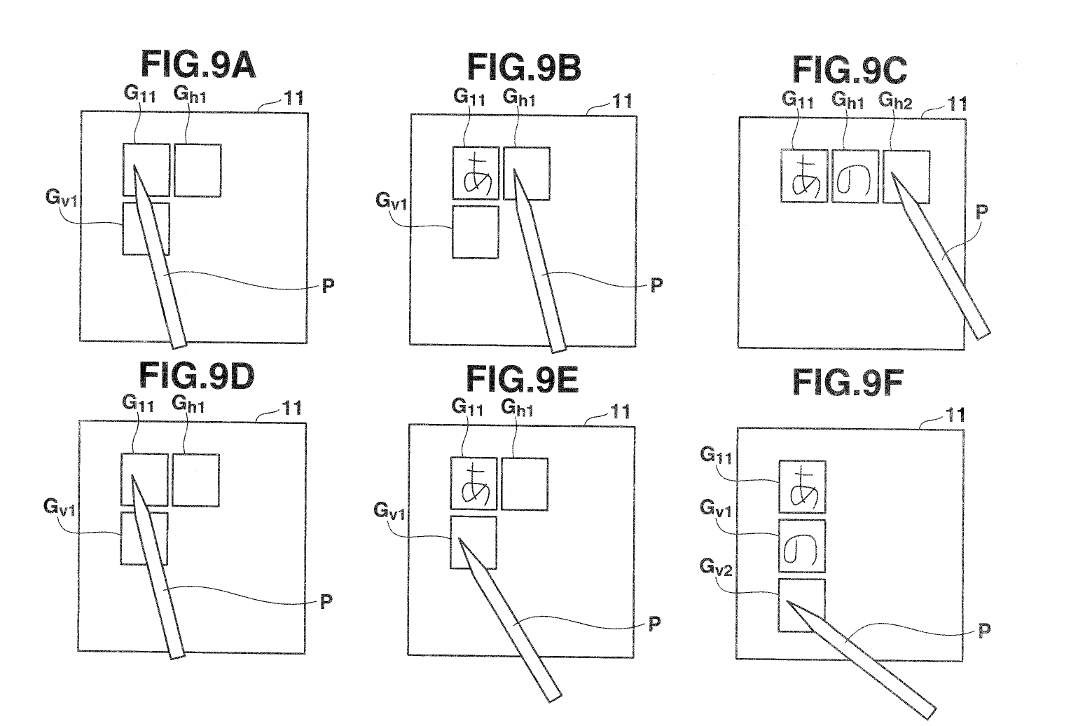

FIGS. 9A, 9B, 9C, 9D, 9E and 9F show views each showing a display operation concomitant with guide display processing according to a fourth embodiment carried out in accordance with a handwriting input operation of the information terminal device 10.

In the guide display processing according to the fourth embodiment, the guide figure Gn for default display to be stored in the guide figure database 22d is constituted of guide figures G11, Gh1, and Gv1 formed by combining guide figure G11 for the first character, guide figure Gh1 for the horizontally written second character located on the right of guide figure G11, and guide figure Gv1 for the vertically written second character located beneath guide figure G11.

Further, the configuration is employed in which when a handwritten character is input to the area of guide figure Gh1 for the horizontally written second character, and is recognized as shown in FIGS. 9A to 9C, guide figure Gv1 for the vertically written second character is erased, and succeeding guide figures Gh2, . . . are additionally displayed in sequence subsequent to guide figure Gh1 in the rightward direction and, when a handwritten character is input to the area of guide figure Gv1 for the vertically written second character, and is recognized as shown in FIGS. 9D to 9F, guide figure Gh1 for the horizontally written second character is erased, and succeeding guide figures Gv2, . . . are additionally displayed in sequence subsequent to guide figure Gv1 in the downward direction.

According to the above, it is possible for the user, irrespectively of whether the user wants to horizontally write characters by handwriting or the user wants to vertically write characters by handwriting, to clearly recognize guide figures Ghn . . . or guide figures Gvn . . . to be extensionally displayed subsequently in the input direction of the handwritten characters while inputting the handwritten characters, and it is possible to impart a more effective guiding function (which may be referred to as a guide figure selection unit) having a high degree of operability to the information terminal device 10.

It should be noted that in the embodiment described above, although the specific examples including guide figure G0001 for hiragana, katakana, and Chinese characters, and guide figure G002 for alphabetic characters have been described as the guide figure Gn to be used for the guide display processing for handwriting input, it goes without saying that the embodiment is not limited to these character types.

Each of the methods of the processing items to be carried out in the information terminal device 10, and database which are described in each of the aforementioned embodiments, i.e., each of the methods of the guide display processing according to the first embodiment shown in the flowchart of FIG. 5, guide display processing according to the second embodiment shown in the flowchart of FIG. 6, guide display processing according to the third embodiment shown by the display operation of FIGS. 8A, 8B and 8C, guide display processing and the like of the fourth embodiment shown by the display operation of FIGS. 9A, 9B, 9C, 9D, 9E and 9F, and the database such as the guide figure database 22d shown in FIG. 3 can be stored in an external recording medium (23) such as a memory card (ROM card, RAM card, and the like), magnetic disk (floppy disk, hard disk, and the like), optical disk (CD-ROM, DVD, and the like), semiconductor memory, and the like, and can be distributed as a program which can be executed by a computer. Further, the computer (21) of each of various types of information terminal devices (10) each of which is provided with the tablet display unit (11) reads the program stored in the external recording medium (23) into the storage device (22), and the operation of the device is controlled by the read program, whereby it is possible to realize the guide display function concomitant with the handwriting input processing described in each of the aforementioned embodiments, and execute the identical processing by the aforementioned method.

Further, it is possible to transmit data of the program for realizing each of the aforementioned methods on a communication network in the form of a program code, and it is also possible to realize the guide display function concomitant with the handwriting input processing described in each of the aforementioned embodiments by capturing the program data on the computer (21) of each of the various types of information terminal devices (10) each of which is connected to the communication network, and is provided with the tablet display unit (11).

It should be noted that the present invention is not limited to the aforementioned embodiments, and can be variously modified in the implementation stage within a range not deviating from the essence of the invention. Furthermore, inventions of various stages are included in each of the aforementioned embodiments, and by appropriately combining a plurality of disclosed configuration conditions with each other, various inventions can be extracted. For example, even when some configuration conditions are deleted from the all the configuration conditions shown in the embodiments or some configuration conditions are combined in different forms, if the problem described in the paragraph of “Problem to Be Solved” can be solved, and the advantage described in the paragraph of “Advantage of the Invention” can be obtained, the configuration conditions obtained after deletion of some of the conditions or the combined configuration can be extracted as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A handwriting input device comprising:
a display unit;
a position detecting unit provided integral with the display unit and configured to detect an access position and a contact position of an operation tool;
a guide figure display unit configured to, when an access position of the operation tool is detected by the position detecting unit, display a guide figure for handwriting input on the display unit based on the detected access position; and
a handwriting position display unit configured to, when a contact position of the operation tool is detected by the position detecting unit in a state where the guide figure is displayed by the guide figure display unit, display a locus of the detected contact position on the display unit.

2. The handwriting input device according to claim 1, further comprising:
a character recognition unit configured to recognize the locus of the contact position of the operation tool displayed by the handwriting position display unit as a character; and
a guide figure switch/display unit configured to switch a guide figure displayed by the guide figure display unit to a new guide figure according to a character type of a character recognized by the character recognition unit, and display the new guide figure.

3. The handwriting input device according to claim 1, further comprising
a guide figure addition/display unit configured to, according to a situation where a locus of the contact position of the operation tool is displayed by the handwriting position display unit in an area of the guide figure displayed on the display unit, additionally display an identical guide figure subsequent to a display position of the guide figure.

4. The handwriting input device according to claim 2, further comprising
a guide figure addition/display unit configured to, according to a situation where a locus of the contact position of the operation tool is displayed by the handwriting position display unit in an area of the guide figure displayed on the display unit, additionally display an identical guide figure subsequent to a display position of the guide figure.

5. The handwriting input device according to claim 1, wherein
the guide figure display unit displays a guide figure formed by combining a guide figure for two leading horizontally written characters, and a guide figure for two leading vertically written characters with each other, and
the device further comprises
a guide figure selection unit configured to, when a locus of the contact position of the operation tool is displayed by the handwriting position display unit in an area of the second character of the guide figure for horizontal writing, erase the display of the guide figure for vertical writing and, when a locus of the contact position of the operation tool is displayed by the handwriting position display unit in an area of the second character of the guide figure for vertical writing, erase the display of the guide figure for horizontal writing.

6. The handwriting input device according to claim 2, wherein
the guide figure display unit displays a guide figure formed by combining a guide figure for two leading horizontally written characters, and a guide figure for two leading vertically written characters with each other, and
the device further comprises
a guide figure selection unit configured to, when a locus of the contact position of the operation tool is displayed by the handwriting position display unit in an area of the second character of the guide figure for horizontal writing, erase the display of the guide figure for vertical writing and, when a locus of the contact position of the operation tool is displayed by the handwriting position display unit in an area of the second character of the guide figure for vertical writing, erase the display of the guide figure for horizontal writing.

7. The handwriting input device according to claim 3, wherein
the guide figure display unit displays a guide figure formed by combining a guide figure for two leading horizontally written characters, and a guide figure for two leading vertically written characters with each other, and
the device further comprises
a guide figure selection unit configured to, when a locus of the contact position of the operation tool is displayed by the handwriting position display unit in an area of the second character of the guide figure for horizontal writing, erase the display of the guide figure for vertical writing and, when a locus of the contact position of the operation tool is displayed by the handwriting position display unit in an area of the second character of the guide figure for vertical writing, erase the display of the guide figure for horizontal writing.

8. The handwriting input device according to claim 4, wherein
the guide figure display unit displays a guide figure formed by combining a guide figure for two leading horizontally written characters, and a guide figure for two leading vertically written characters with each other, and
the device further comprises
a guide figure selection unit configured to, when a locus of the contact position of the operation tool is displayed by the handwriting position display unit in an area of the second character of the guide figure for horizontal writing, erase the display of the guide figure for vertical writing and, when a locus of the contact position of the operation tool is displayed by the handwriting position display unit in an area of the second character of the guide figure for vertical writing, erase the display of the guide figure for horizontal writing.

9. The handwriting input device according to claim 1, further comprising a guide figure erasing unit configured to erase the guide figure when the handwriting input is completed.

10. The handwriting input device according to claim 2, further comprising a guide figure erasing unit configured to erase the guide figure when the handwriting input is completed.

11. The handwriting input device according to claim 3, further comprising a guide figure erasing unit configured to erase the guide figure when the handwriting input is completed.

12. The handwriting input device according to claim 4, further comprising a guide figure erasing unit configured to erase the guide figure when the handwriting input is completed.

13. The handwriting input device according to claim 5, further comprising a guide figure erasing unit configured to erase the guide figure when the handwriting input is completed.

14. The handwriting input device according to claim 6, further comprising a guide figure erasing unit configured to erase the guide figure when the handwriting input is completed.

15. The handwriting input device according to claim 7, further comprising a guide figure erasing unit configured to erase the guide figure when the handwriting input is completed.

16. The handwriting input device according to claim 8, further comprising a guide figure erasing unit configured to erase the guide figure when the handwriting input is completed.

17. A non-transitory computer-readable medium having a program stored thereon for controlling a computer of an electronic device including a display unit, and a position detecting unit provided integral with the display unit and configured to detect an access position and a contact position of an operation tool, to perform functions comprising:
a guide figure display function of displaying, when an access position of the operation tool is detected by the position detecting unit, a guide figure for handwriting input on the display unit based on detected access position; and
a handwriting position display function of displaying, when a contact position of the operation tool is detected by the position detecting unit in a state where the guide figure is displayed by the guide figure display function, a locus of the detected contact position on the display unit.
